(19) United States
(12) Patent Application Publication
(10) Pub. No.: US 2016/0378570 A1
(43) Pub. Date: Dec. 29, 2016

(54) Techniques for Offloading Computational Tasks between Nodes

(71) Applicants: Igor LJUBUNCIC, London (GB); Raphael SACK, Mitzpe Amuka (IL); Tatyana DYSHKANTIUK, Nahariyya (IL); Tomer RIDER, Naahryia (IL); Shahar TAITE, kfar saba (IL)

(72) Inventors: Igor LJUBUNCIC, London (GB); Raphael SACK, Mitzpe Amuka (IL); Tatyana DYSHKANTIUK, Nahariyya (IL); Tomer RIDER, Naahryia (IL); Shahar TAITE, kfar saba (IL)

(21) Appl. No.: 14/750,453

(22) Filed: Jun. 25, 2015

(51) Int. Cl. G06F 9/50

(52) U.S. Cl. CPC G06F 9/5088

(57) ABSTRACT

Examples may include techniques to offload computational tasks between nods. The computational tasks offloaded based on computing resources hosted by a given node exceeding an energy state threshold and based on another node accepting the offloading of the computational task. The other node to accept the offload based on a determination that computing resources hosted by the other node do not exceed an energy state threshold for the other node when used to execute the offloaded computational task.

### TECHNICAL FIELD

Examples described herein are generally related to executing computational tasks by various nodes hosting computing resources.

### BACKGROUND

Various computational tasks or jobs for providing services supported by a data center may include use of various computing resources located at or with host computing platforms or nodes. These computational tasks may be associated with processing, storage, networking or management services for customers or clients seeking data center services. Large data centers may include multitudes of nodes interconnected to each other via one or more network communication channels. The network communication channels may include in-band communication channels arranged to relay data to and from nodes in order for these nodes to execute computational tasks. The network communication channels may also include out-of-band (OOB) communication channels. OOB communication channels may be arranged to allow for managing or controlling nodes remotely and/or may allow for communication between nodes.

Typically, a centralized dispatcher or scheduler may act as a single point of control for distributing computational tasks between nodes in a data center. The central dispatcher may communicate with nodes through a server-client method that includes building a list of nodes and their respective capabilities. These capabilities may include the numbers and types of computing resources for use in executing computational tasks. The central dispatcher typically schedules computational tasks for execution at nodes and attempts to make best use of critical operating parameters in order to meet data center service obligations. Operating parameters for computing resources such as processor utilization, memory utilization, storage utilization, license keys, estimated execution time, concurrency, priority or other operating parameters may be taken into consideration when scheduling computational tasks.

### BRIEF DESCRIPTION OF THE DRAWINGS

FIG. 1 illustrates an example system.

FIG. 2 illustrates an example first allocation.

FIG. 3 illustrates an example second allocation.

FIG. 4 illustrates an example report.

FIG. 5 illustrates an example process.

FIG. 6 illustrates an example block diagram for an apparatus.

FIG. 7 illustrates an example of a first logic flow.

FIG. 8 illustrates an example of a second logic flow.

FIG. 9 illustrates an example of a storage medium.

FIG. 10 illustrates an example computing platform.

### DETAILED DESCRIPTION

As contemplated in the present disclosure, operating parameters for computing resources such as processor utilization, memory utilization, storage utilization, license keys, estimated execution time, concurrency, priority or other operating parameters may be taken into consideration when scheduling computational tasks. In some examples various algorithms may be used for this type of centralized scheduling such as first-in-first-out (FIFO), shortest-job-first (SJF) or round-robin (RR). Also, when an allocation of computing resources is needed due to, for example, a new computational task, existing computational tasks as well as the new computational task may be submitted to those nodes having best available capacity. This best available capacity may be based on client-server polling of critical operating parameters. The polling may allow a central scheduler to determine utilization rates or critical operating parameters for each node such as processor utilization, memory utilization or storage utilization.

In general, exact prediction of computing resource usage or runtimes for various computing resources hosted by each node may be deterministically impossible. Although approximations (to varying degrees of accuracy) may exist. Inevitably, in large data center environments running heterogeneous computational tasks, centralized scheduling may be bounded toward an upper limit of capabilities for computing resources hosted by nodes. This means that there may always be idle capacity and thus some computing resources may be “neglected” or inefficiently utilized when using centralized scheduling. It is with respect to these challenges that the examples described herein are needed.

According to some examples, techniques to offload computational tasks between nodes may include a node (e.g., located in a data center) receiving a computational task for execution by computing resources hosted by the node. Logic and/or features at the node may then determine that execution of the computational task causes an energy state of the node to exceed an energy state threshold. An indication may then be broadcasted to indicate that the energy state threshold has been exceeded to one or more nodes (e.g., also located in the data center). The indication may be broadcast over an out-of-band (OOB) communication channel maintained with the one or more nodes. The logic and/or features may then receive one or more reports from the one or more nodes over the OOB communication channel, the one or more reports indicating respective energy states of the one or more nodes. The logic and/or features may then select an offload node from the one or more nodes based on the one or more reports and offload the computational task to the offload node responsive to the offload node accepting a request to execute the computation task.

According to some other examples, techniques to offload computation tasks between nodes may include a first node (e.g., included in a data center) receiving a message from a second node (e.g., also included in the data center) over an OOB communication channel between the first and second nodes. For these other examples, the message may indicate that an energy state threshold for the second node has been exceeded. Logic and/or features at the first node may then send a report to the second node over the OOB communication channel that indicates an energy state of the first node. A request to execute a computational task offloaded from the second node may then be received and the logic and/or features may accept the request and then cause the first node to execute the computational task using computing resources hosted by the first node.

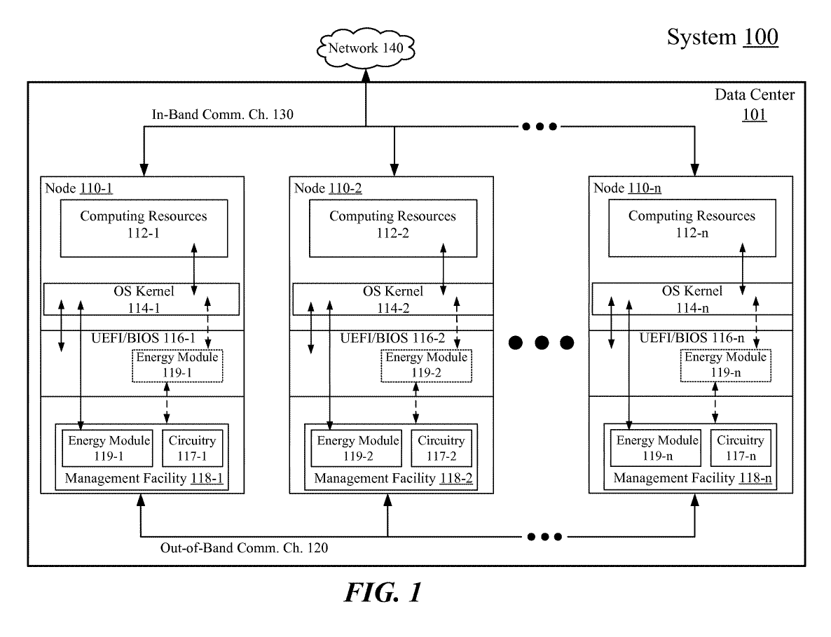

FIG. 1 illustrates an example system 100. As shown in FIG. 1, in some examples, system 100 includes a data center 101 having nodes 110-1 to 110-n, where “n” is any whole positive integer greater than 2. Nodes 110-1 to 110-n may be coupled to a network 140 via an in-band communication channel 130 to provide one or more network or data center services to clients or customers (not shown) that may have access to data center 101 through network 140. According to some examples, data associated with executing computational tasks for providing the one or more network or data center services may be received or transmitted over in-band communication channel 130. For example, the one or more network or data center services may include, but are not limited to, application services such as web or e-mail hosting. The data flowing to and from nodes 110-1 to 110-n over in-band communication channel 130 may be for executing computational tasks associated with providing these application services.

In some examples, as shown in FIG. 1, nodes 110-1 to 110-n each include computing resources 112, an OS kernel 114, a unified extensible firmware interface/basic input/output system (UEFI/BIOS) 116 and a management facility 118. Also as shown in FIG. 1, each management facility 118 may include circuitry 117 and an energy module 119. As described more below, respective logic and/or features of a given management facility 118 may facilitate OOB communications over out-of-band communication channel 120 in order to offload computational tasks between nodes 110-1 to 110-n. This offloading may enable a self-scheduling environment between nodes 110-1 to 110-n based on setting energy state thresholds at each node that cause nodes to offload computational tasks responsive to a self-determination of whether these energy state thresholds have been exceeded.

According to some examples, energy state thresholds at each node may be based on maintaining a minimum energy state. This minimum energy state may be bounded towards a lower limit or lower capacity for various types of computing resources included in respective computing resources 112-1 to 112-n hosted by nodes 110-1 to 110-n. In other words, rather than allocating up to 100% of computing resources for executing computational tasks, lower allocations (e.g., 50%) may be established. These lower allocations may set energy state thresholds such that should a node suddenly have a need for higher allocations of computing resources to execute computational tasks that results in the energy state threshold being exceeded, at least some computational tasks may be offloaded to another node with enough capacity below its set energy state threshold to take on the offloaded computational task. Thus, a new equilibrium among the nodes may be established that attempts to keep each node below its respective energy state thresholds while using their hosted computing resources to execute computational tasks.

In some examples, minimum energy states bounded towards a lower limit may also reduce or eliminate the need to identify critical nodes in a data center. For these examples, critical nodes may be eliminated as computational tasks may be quickly offloaded from a potentially failing node to other nodes having a built in margin of capacity. Once a failed node is brought back on line, equilibrium may be reestablished as computational task are handed back to this node from nodes that may have temporarily exceeded their energy state thresholds while the failed node was off line. Eliminating critical nodes may reduce the need to over build or over allocate computing resources for some nodes and may also reduce the need for costly redundant secondary nodes that may host idle computing resources while a primary node hosts active computing resources to execute computational tasks.

According to some examples, as shown in FIG. 1, each management facility 118 includes an energy module 119. Energy module 119 may include logic and/or features (e.g., executed by circuitry 117) to communicate with OS kernel 114 to determine an energy state of computing resources 112. For these examples, OS kernel 114 may provide computational task information to the logic and/or features of energy module 119 for these logic and/or features to determine whether execution of a given computation task (e.g., a new computational task) causes computing resources 112 to exceed an energy state threshold. OS kernel 114, for example, may include various device drivers or other interfaces (not shown) capable of forwarding operating parameters associated with computing resources 112 to energy module 119. The forwarded operating parameters may enable the logic and/or features of energy module 119 to determine what amount of allocated capacity is currently in use and/or what capacity is available. The logic and/or features may then use computational task information to determine whether the energy state threshold is or will be exceeded if the computational task is executed by computing resources 112.

In some examples, energy module 119 may be programmable logic programmed into UEFI/BIOS 116 as depicted in FIG. 1 as the dotted-box. For these examples, logic and/or features of energy module 119 may communicate with OS kernel 114 as mentioned above and may also utilize management facility 118 to communicate over out-of-band communication channel 120 with other nodes for possibly causing offloading or receiving information for possibly taking on an offloaded computational task from another node.

Computing resources 112 may include, but are not limited to, hardware-based types of computing resources such as processors, memory devices, storage devices, graphics processors, network I/O devices, switch devices, cooling devices, power devices. Computing resources 112 may also include, but are not to, software-based types of computing resources such as operating systems, virtual machines, virtualized containers or applications. As described more below, computing resources 112 may be allocated on a cumulative basis or may be allocated on an individual basis to establish an energy state threshold.

According to some examples, management facility 118 may be arranged as an active management technology (AMT) management engine according to an industry technology such as Intel® AMT 7.0 Release, Rev. 1.0, published in October 2010 (“the AMT specification”) and/or other releases or versions. Management facility 118 may also be arranged to work with processors or other computing resources included in computing resources 112 that may be arranged to operate with another industry technology such as Intel® vPro™. For these examples, respective management facilities 118 at nodes 110-1 to 110-n may facilitate communication between nodes over out-of-band communication channel 120. Out-of-band communication channel 120 may be arranged to operate as an AMT OOB communication channel that transports data between nodes 110-1 to 110-n using communication protocols described in the AMT specification.

In some examples, management facility 118 may be arranged as a simple network management protocol (SNMP) agent according to one or more industry technologies or standards such as those included in the Internet Protocol Suite as defined by the Internet Engineering Task Force (IETF) for SNMP version 3 (SNMPv3) as described in Request for Comments (RFCs) 3411 to 3418 (the SNMPv3 standards”) and/or later or earlier versions. For these examples, management facility 118 may operate as the SNMP agent to facilitate communication between nodes 110-1 to 110-n over out-of-band communication channel 120. Out-of-band communication channel 120 may be arranged to operate as an SNMP OOB communication channel that transports data between nodes 110-1 to 110-n using communication protocols described in the SNMPv3 standards.

According to some examples, management facility 118 may be arranged as a baseband management controller (BMC) according to one or more industry technologies or standards associated with an Intelligent Platform Management Interface (IPMI). The one or more standards may include the IPMI Specification Second Generation, v2.0, Revision 1.1, published in October 2013 (“the IPMI specification”), and/or other versions or revisions. For these examples, management facility 118 may facilitate communication between nodes 110-2 to 110-n over out-of-band communication channel 120. Out-of-band communication channel 120 may be arranged to operate as an IPMI OOB communication channel that transports data between nodes 110-1 to 110-n using communication protocols described in the IPMI specification.

In some examples, whether a given management facility 118 at nodes 110-1 to 110-n is arranged as an AMT management engine, SNMP agent or BMC, each example may provide a way in which logic and/or features included in a module such as energy module 119-1 may include built in capabilities for nodes 110-1 to 110-n to manage self-scheduling of computational tasks between each other without dependence on an operating system/application or dependence on a centralized scheduler.

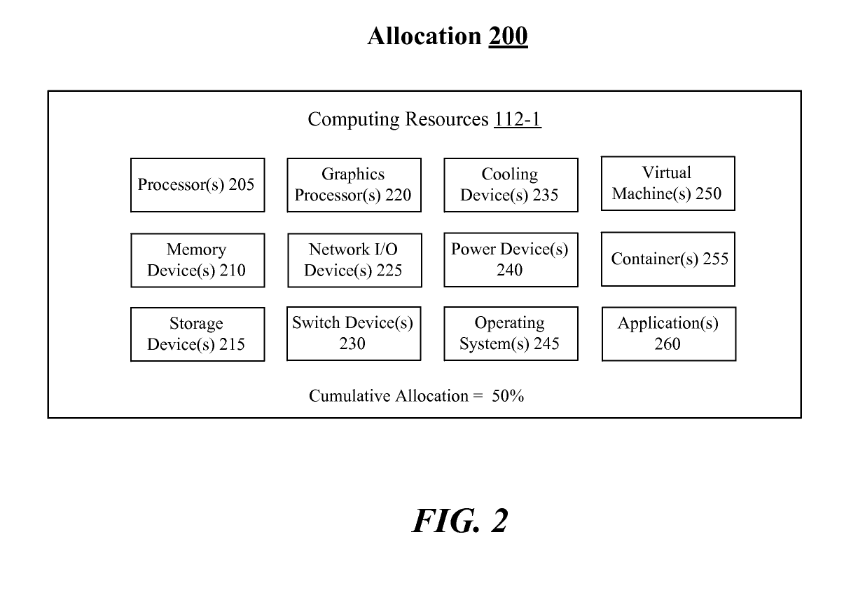

FIG. 2 illustrates an example first allocation. As shown in FIG. 2, the example first allocation includes allocation 200. In some examples, as shown in FIG. 2, allocation 200 includes a cumulative allocation of 50% for various types of hardware-based or software-based computing resources included in computing resources 112-1 hosted by node 110-1. For example, hardware-based types of computing resources may include, but are not limited to, processor(s) 205, memory device(s) 210, storage device(s) 215, graphics processor(s) 220, network I/O device(s) 225, switch device(s) 230, cooling device(s) 235, power device(s) 240. Software-based types of computing resources may include, but are not limited to, operating system(s) 245, virtual machine(s) 250, container(s) 255 or application(s) 260. Similar or different computing resources as those shown in FIG. 2 for computing resources 112-1 may be hosted by other nodes of data center 101. Also, similar or different cumulative allocations may be set or established for these computing resources hosted by other nodes of data center 101.

In some examples, energy module 119-1 may include logic and/or features to receive operating parameters including available capacities or utilization rates associated with the various computing resources included in computing resources 112-1. These operating parameters may be forwarded by OS kernel 114-1 to energy module 119-1 to determine what amount of allocated capacity is currently in use and/or what capacity is available. This determination may be based on computational task(s) currently being executed or may be based on expected or recently received computational task(s) for execution by computing resources 112-1. The logic and/or features of energy module 119-1 may then determine whether execution of current or expected computational task(s) causes an energy state of node 110-1 to exceed an energy state threshold. For the example allocation 200 shown in FIG. 2 the energy state threshold would be exceeded if execution of current or expected computational task(s) causes computing resources 112-1 to reach a level greater than 50% of potential capacity. In other words, if greater than 50% of the cumulative capacity of hardware-type and software-type computing resources would be utilized to execute the current or expected computational task(s), then at least some computational tasks would need to be offloaded to bring node 110-1's energy state below its energy state threshold.

According to some examples, energy module 119-1 may not only determine whether an energy state threshold has been exceeded but may also determine amount of available capacity if other nodes are seeking to offload computational task to node 110-1. As described more below, logic and/or features of energy module 119-1 may generate a report indicating this available capacity responsive to a message received from a given node over out-of-band communication channel 120 indicating a need for the given node to offload a computational task. For example, if the logic and/or features determine that computing resources 112-1 are operating at 40% capacity then a report may be sent to the given node indicating that node 110-1 is currently operating at an energy state of 40% capacity with an energy state threshold of 50% capacity. Logic and/or features of energy module 119-1 may then receive a request from given node requesting offloading of a computational task for execution by computing resources 112-1. Acceptance of the request may then be contingent on whether logic and/or features of energy module 119-1 determine that execution of the proposed offloading of the computational task causes computing resources 112-1 to exceed the cumulative allocation of 50% capacity.

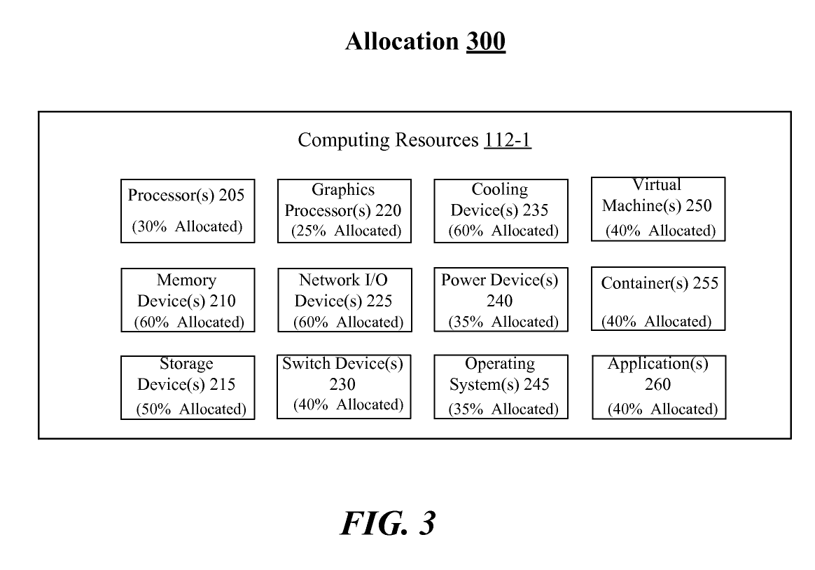

FIG. 3 illustrates an example second allocation. As shown in FIG. 3, the example second allocation includes allocation 300. In some examples, as shown in FIG. 3, allocation 300 includes various percent allocations for different types of hardware-based or software-based computing resources included in computing resources 112-1. For these examples, allocation 300 shows that computing resources 112-1 may be allocated based on separate capacities of individual computing resources hosted by node 110-1.

According to some examples, as shown in FIG. 3, processor(s) 205 may have 30% allocated according to allocation 300. For these examples, processor(s) 205 may include various types of central processing units or CPUs that may include one or more multi-core or single-core processors. Logic and/or features of energy module 119-1 may determine an energy state of processor(s) 205 based on operating parameters received, for example, from OS kernel 114-1. These operating parameters may include, but are not limited to, processor utilization rates (e.g., 25% utilization) while executing computational tasks at node 110-1.

In some examples, as shown in FIG. 3, memory device(s) 210 may be 60% allocated according to allocation 300. For these examples, memory device(s) 210 may include types of memory devices used to provide system memory for executing computational tasks. These types of memory devices may include dual in-line memory modules (DIMMS) composed of types of volatile memory such as random access memory (RAM) or composed of a combination of RAM and types of non-volatile memory such as flash memory. Logic and/or features of energy module 119-1 may determine an energy state of memory device(s) 210 based on received operating parameters. These operating parameters may include, but are not limited to, an indication (e.g., a percentage) of overall system memory being used for executing computational tasks at node 110-1.

According to some examples, as shown in FIG. 3, storage device(s) 215 may be 50% allocated according to allocation 300. For these examples, storage device(s) 215 may include types of storage devices used to store and/or access data associated with executing computational tasks. These types of storage devices may include hard disk drives and/or solid state drives. Logic and/or features of energy module 119-1 may determine an energy state of storage device(s) 215 based on received operating parameters. These operating parameters may include, but are not limited to, disk or drive I/O rates or storage capacity utilization associated with executing computational tasks at node 110-1.

In some examples, as shown in FIG. 3, graphics processor(s) 220 may be 25% allocated according to allocation 300. For these examples, graphics processor(s) 220 may include various types of graphics processor units (GPUs). Logic and/or features of energy module 119-1 may determine an energy state of graphics processor(s) 205 based on operating parameters received. These operating parameters may include, but are not limited to, graphics processor utilization rates while executing at least portions of computational tasks at node 110-1 (e.g., portions associated with graphic rendering or video processing).

According to some examples, as shown in FIG. 3, network I/O device(s) 225 may be 60% allocated according to allocation 300. For these examples, network I/O device(s) 225 may include various types of network I/O devices or network interface cards (NICs) arranged to receive or transmit data (e.g., over in-band communication channel 130) associated with executing computational tasks. Logic and/or features of energy module 119-1 may determine an energy state of network I/O devices 225 based on operating parameters received. These operating parameters may include, but are not limited to, available bandwidth or data packet throughput while processing data packets for transport over in-band communication channel 130 in association with executing computational tasks at node 110-1.

In some examples, as shown in FIG. 3, switch device(s) 230 may be 40% allocated according to allocation 300. For these examples, switch device(s) 230 may include various types of switches arranged to relay data associated with executing computational tasks. The data may be relayed either internally within node 110-1 (e.g., between virtual machines or containers) or externally (between nodes). Switch device(s) 230 may a hardware-based computing resource (e.g., a switching application specific integrated circuit) or may be a software-based computing device (e.g., a software or virtual switch). Logic and/or features of energy module 119-1 may determine an energy state of switch device(s) 230 based on operating parameters received. These operating parameters may include, but are not limited to, data packet throughput while relaying data packets either internally or externally in association with executing computational tasks at node 110-1.

According to some examples, as shown in FIG. 3, cooling device(s) 235 may be 60% allocated according to allocation 300. For these examples, cooling device(s) 235 may include devices used to cool computing resources hosted by node 110-1 while executing computational tasks. These types of cooling devices may include fans or liquid/gas cooling systems. Logic and/or features of energy module 119-1 may determine an energy state of cooling device(s) 235 based on received operating parameters. These operating parameters may include, but are not limited to, an amount of overall cooling capacity being utilized or expected to be utilized while computing resources 112-1 are executing computational tasks at node 110-1.

In some examples, as shown in FIG. 3, power device(s) 240 may be 35% allocated according to allocation 300. For these examples, power device(s) 240 may include devices used to power computing resources hosted by node 110-1 while executing computational tasks. These types of power devices may include power generation modules arranged to provide a required voltage supply to computing resources hosted by node 110-1. Logic and/or features of energy module 119-1 may determine an energy state of power device(s) 240 based on received operating parameters. These operating parameters may include, but are not limited to, an amount of overall power capacity being utilized or expected to be utilized while computing resources 112-1 are executing computational tasks at node 110-1.

According to some examples, as shown in FIG. 3, operating system(s) 245 may be 35% allocated according to allocation 300. For these examples, operating system (s) 245 may include operating systems hosted by node 110-1 for use in executing computational tasks. Operating system for example may include, but are not limited to, Windows®-based, Solaris®-based or Linux-based operating systems. Logic and/or features of energy module 119-1 may determine an energy state of operating system(s) 245 based on received operating parameters. These operating parameters may include, but are not limited to, an amount of processes compared to peak supportable processes being utilized or expected to be utilized while computing resources 112-1 are executing computational tasks at node 110-1.

In some examples, as shown in FIG. 3, virtual machine(s) 250 may be 40% allocated according to allocation 300. For these examples, virtual machine(s) 250 may include virtual machines supported by computing resources hosted by node 110-1 (e.g., processor(s) 205, memory device(s) 210 or operating system(s) 245) for use in executing at least portions of computational tasks. Logic and/or features of energy module 119-1 may determine an energy state of virtual machine(s) 250 based on received operating parameters. These operating parameters may include, but are not limited to, a number of virtual machine(s) actively being utilized or expected to be utilized in executing at least a portion of computational tasks at node 110-1.

In some examples, as shown in FIG. 3, container(s) 255 may be 40% allocated according to allocation 300. For these examples, container(s) 255 may include virtualized containers supported by computing resources hosted by node 110-1 (e.g., processor(s) 205, memory device(s) 210 or operating system(s) 245) for use in executing at portions of computational tasks. Logic and/or features of energy module 119-1 may determine an energy state of container(s) 255 based on received operating parameters. These operating parameters may include, but are not limited to, a number of container(s) actively being utilized or expected to be utilized in executing at least a portion of computational tasks at node 110-1.

In some examples, as shown in FIG. 3, application(s) 260 may be 40% allocated according to allocation 300. For these examples, application(s) 260 may be arranged for use in executing computational tasks at node 110-1. Logic and/or features of energy module 119-1 may determine an energy state of application(s) 260 based on received operating parameters. These operating parameters may include, but are not limited to, data processing throughputs for applications used or expected to be used while computing resources 112-1 are executing computational tasks at node 110-1.

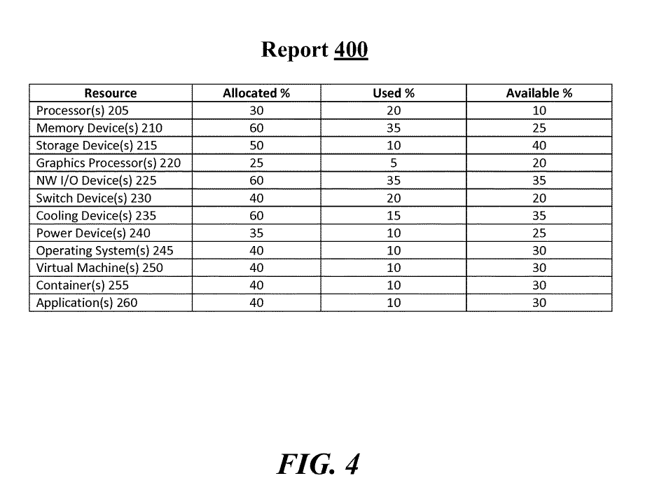

FIG. 4 illustrates an example report 400. In some examples, as shown in FIG. 4, report 400 may be an example report submitted by node 110-1 to indicate an energy state of node 110-1 hosting computing resources 112-1 allocated according to allocation 300 shown in FIG. 3. For these examples, logic and/or features of energy module 119-1 may include individual energy states of computing resources 112-1 in report 400. Example report 400 may be generated responsive to a message received from one of nodes 110-2 to 110-n over out-of-band communication channel 120 that indicates an energy state threshold has been exceeded for one of these other nodes. Example report 400, as shown in FIG. 4, may include an indication of allocated %, used % or available % for each of the computing resources hosted by node 110-1.

According to some examples, the originating or offloading node of the message that indicated its energy state threshold has been exceeded may compare report 400 to reports received from other nodes. The comparison of reports may determine which node to offload a computational task. If the offloading node chooses node 110-1, then the offloading node sends a request to offload the computational task. The request, for example, may include information via which logic and/or features of energy module 119-1 may be able to determine whether an energy state threshold for at least one computing resource included in computing resources 112-1 would be exceeded if the offloaded computational task was executed at node 110-1. If the energy state threshold for at least one computing resource is not exceeded, the logic and/or features of energy module 119-1 may cause node 110-1 to accept the request to offload the computational task for execution by computing resources 112-1. If exceeded, the logic and/or features of energy module 119-1 may cause node 110-1 to reject the request. For example, if the offloaded computational task is expected to increase the used % for processor(s) 205 above the energy state threshold of 30% utilization, then the request to offload the computational task may be rejected.

In other examples, a report that merely indicates an overall or cumulative allocation %, used % and available % for computing resources 112-1. The cumulative allocation may be based on or similar to allocation 200 shown in FIG. 2. For these examples, the logic and/or features of energy module 119-1 may assess a request for offloading of a computing task based on the overall energy state of computing resources 112-1 rather than looking at separate energy states for each individual computing resource.

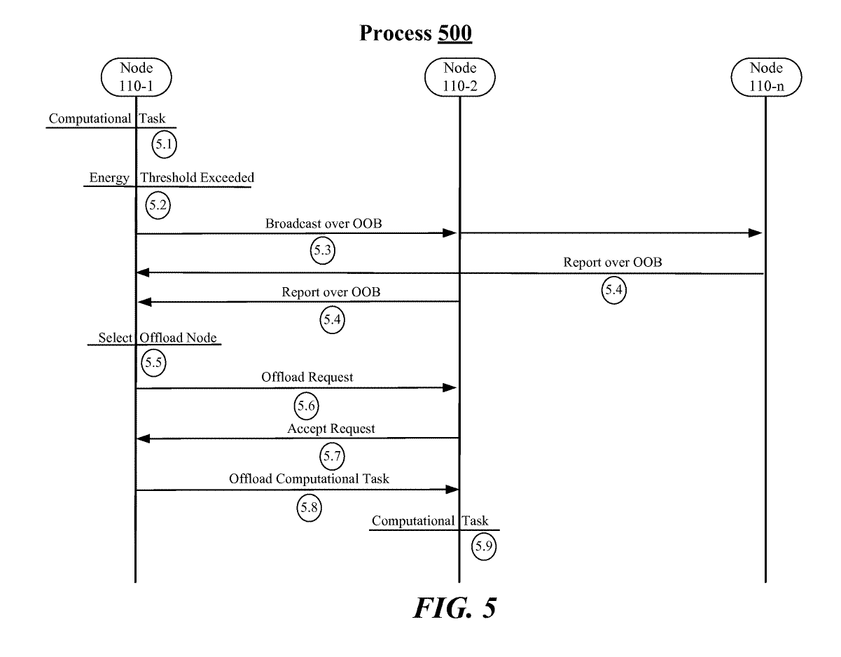

FIG. 5 illustrates an example process 500. Process 500 may be associated with offloading computational tasks between nodes. For these examples, at least some components of system 100 shown in FIG. 1 may be related to process 500. Also, allocations 200 or 300 shown in FIGS. 2-3 and report 400 shown in FIG. 4 may be related to process 500 However, the example process 500 is not limited to implementations using components of system 100 shown or described in FIG. 1 or the allocations and report shown or described in FIGS. 2-4.

Starting at process 5.1 (Computational Task), node 110-1 may receive or may be currently executing a computational task for providing a data center service. The data center service, for example, may be provided by nodes 110-1 to 110-n of data center 101 coupled to customers or subscribers to the data center service through network 140. Node 110-1 may utilize computing resources 112-1 to execute the computational task.

Moving to process 5.2 (Energy Threshold Exceeded), logic and/or features of energy module 119-1 located at node 110-1 may determine that execution of the computational task causes an energy state of node 110-1 to exceed an energy state threshold. In some examples, if allocation 200 sets the energy state threshold, then the logic and/or features has determined that execution of the computational task causes the cumulative allocated computing resources to exceed 50% for computing resources 112-1. In some examples, if allocation 300 for computing resources sets individual energy state thresholds, then the logic and/or features of energy module 119-1 has determined that execution of the computational task causes or is expected to cause at least one allocated computing resource from among computing resources 112-1 to exceed its individually allocated %. For example, memory device(s) 210 exceed or are expected to exceed an energy state of 60% when executing the computational tasks. According to some examples, the logic and/or features of energy module 119-1 may receive computational task information that includes operating parameters for the various computing resources included in computing resources 112-1 from OS kernel 114-1. The logic and/or features may then use that computational task information to determine energy state(s).

In some examples, the logic and/or features of energy module 119-1 may also use a different allocation than allocation 200 or allocation 300 to determine whether an allocation % has been exceeded. For example, the different allocation may group or establish subsets of computing resources having grouped allocations. For examples, processor(s) 205 and memory device(s) 210 may be a first subset having a grouped allocation of 50% and operating system(s) 245, container(s) 255 and application(s) 260 may be a second subset having a grouped allocation of 45%. Using these different allocations logic and/or features of energy module 119-1 may have determined that execution of the computational task causes or is expected to cause at least one subset of computing resources 112-1 to exceed its grouped allocated %.

Moving to process 5.3 (Broadcast over OOB), logic and/or features of energy module 119-1 may then broadcast an indication that the energy state threshold of node 110-1 has been exceeded. This indication may be broadcast over an out-of-band (OOB) communication channel such as out-of-band communication channel 120 shown in FIG. 1. As shown in FIG. 5 for process 500, the indication may be broadcast to nodes 110-2 to 110-n. The indication, for example, may be included in a message. This message may be formatted using communication protocols described in one or more of the AMT specification, the SNMPv3 standards or the IPMI specification. Although examples are not limited to messages using communication protocols described in these industry standards or specification. Other communication protocols are contemplated.

Moving to process 5.4 (Report over OOB), logic and/or features at nodes 110-2 to 110-n, responsive to receiving the indication from node 110-1, may send individual reports over the OOB communication channel that indicate respective energy states of nodes 110-2 to 110-n. In some examples, the individual reports may be in a format similar to report 400 shown in FIG. 2 and may indicate available capacity of computing resources 112-2 to 112-n respectively hosted by nodes 110-2 to 110-n before exceeding energy state thresholds for these computing resources.

Moving to process 5.5 (Select Offload Node), logic and/or features of energy module 119-1 at node 110-1 may select a node from nodes 110-2 to 110-n based on reports received from these nodes. In some examples, the logic and/or features may select node 110-2 as the offloading node based on node 110-2 sending a report that indicates a greater available capacity compared to available capacity indicated by other nodes in their respective reports.

Moving to process 5.6 (Offload Request), logic and/or features of energy module 119-1 may cause node 110-1 to send a request to node 110-2 to offload the computational task.

Moving to process 5.7 (Accept Request), logic and/or features of energy module 119-2 at node 110-2 may accept the request to offload the computational task for execution by computing resources 112-2 hosted by node 110-2. In some examples, the request may have included information for the logic and/or feature of energy module 119-2 to determine whether an energy state threshold of node 110-2 would be exceeded if the computational task was executed by computing resources 112-2. The logic and/or features of energy module 119-2 may base this determination on whether a cumulative allocation similar to allocation 200 or an individual allocation similar to allocation 300 is used to set the energy state threshold. For example, if allocation 200, then the computation task's impact on the cumulative energy state of computing resources 112-2 is considered. If allocation 300, then the computational task's impact on individual computing resources included in computing resources are considered.

Moving to process 5.8 (Offload Computational Task), logic and/or features of energy module 119-1 may cause the computational task to be offloaded to node 110-2 responsive to node 110-2 accepting the request to offload the computational task. In some examples, the logic and/or features of energy module 119-1 may cause the computational task to be offloaded by sending an indication to OS kernel 114-1 to offload the computational task to node 110-2.

Moving to process 5.9 (Computational Task), logic and/or features of energy module 119-1 may cause the offloaded computational task to be executed using computing resources 112-2 hosted by node 110-2. In some examples, the logic and/or features may send an indication to OS kernel 114-2 that includes information to indicate the expected offloading of the computational task. This indication may be an implicit acknowledgement that the new computational task is not expected to cause computing resources 112-2 to exceed node 110-2's energy state threshold. Process 500 then comes to an end.

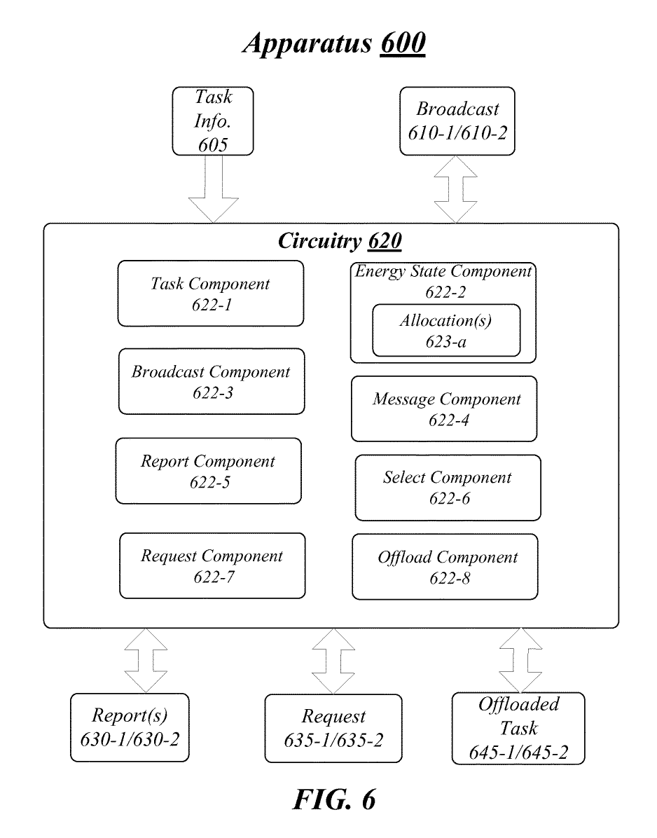

FIG. 6 illustrates an example block diagram for apparatus 600. Although apparatus 600 shown in FIG. 6 has a limited number of elements in a certain topology, it may be appreciated that the apparatus 600 may include more or less elements in alternate topologies as desired for a given implementation.

According to some examples, apparatus 600 may be supported by circuitry 620. Circuitry 600 may be similar to circuitry 117 maintained at or with management facilities 118 maintained at nodes 110-1 to 110-n shown in FIG. 1. Circuitry 600 being similar to circuitry 117 may be for examples where an energy module 119 is located with a management facility 118. In some examples, where energy module 119 may be located as programmed logic in UEFI/BIOS 116, circuitry 600 may part of processor computing resources such as processor(s) 205 included in computing resources 112-1.

In some examples, circuitry 620 may be arranged to execute one or more software or firmware implemented modules or components 622-a. It is worthy to note that “a” and “b” and “c” and similar designators as used herein are intended to be variables representing any positive integer. Thus, for example, if an implementation sets a value for a=8, then a complete set of software or firmware for components 622-a may include components 622-1, 622-2, 622-3, 622-4, 622-5, 622-6, 622-7 or 622-8. The examples presented are not limited in this context and the different variables used throughout may represent the same or different integer values. Also, these “components” may be software/firmware stored in computer-readable media, and although the components are shown in FIG. 6 as discrete boxes, this does not limit these components to storage in distinct computer-readable media components (e.g., a separate memory, etc.).

According to some examples, circuitry 620 may include a processor, processor circuit or processor circuitry. Circuitry 620 may be generally arranged to execute one or more software components 622-a. Circuitry 620 may be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 620 may also include an application specific integrated circuit (ASIC) and at least some components 622-a may be implemented as hardware elements of the ASIC.

In some examples, apparatus 600 may include a task component 622-1. Task component 622-1 may be executed by circuitry 620 to receive information for a computational task to be executed by the computing resources hosted by a first node including apparatus 600. For these examples, the information may be included in task info. 605. Task info. 605 may have been sent from an OS kernel of the first node and may include operating parameter information associated with computing resources hosted by the first node that may be used for executing the computational task.

According to some examples, apparatus 600 may also include an energy state component 622-2. Energy state component 622-2 may be executed by circuitry 620 to determine that execution of the computational task causes an energy state of the first node to exceed an energy state threshold. For these examples, energy state component 622-2 may maintain allocations 623-a in a memory structure such as a lookup table (LUT). Allocations 623-a may be similar to either a cumulative allocation 200 shown in FIG. 2, an individual allocation 300 shown in FIG. 3 or a group allocation mentioned for process 500 for computing resources hosted by the first node. Energy state component 622-2 may use computational task information included in task info. 605 as well as which allocation scheme is used to determine whether the computational task causes the energy state of the first node to exceed the energy state threshold.

In some examples, apparatus 600 may also include a broadcast component 622-3. Broadcast component 622-3 may be executed by circuitry 620 to broadcast an indication that the energy state threshold has been exceeded to one or more nodes, the indication broadcast over an OOB communication channel maintained with the one or more nodes. For these examples, broadcast 610-1 may be a message that includes this indication broadcasted from the first node.

According to some examples, apparatus 600 may also include a message component 622-4. Message component 622-4 may be executed by circuitry 620 to receive a message from a second node from among the one or more nodes over the OOB communication channel, the message may indicate that an energy state threshold for the second node has been exceeded. For these examples, the message may be included in broadcast 610-2.

In some examples, apparatus 600 may also include a report component 622-5. Report component 622-5 may be executed by circuitry 620 to receive one or more reports from the one or more nodes over the OOB communication channel, the one or more reports indicating respective energy states of the one or more nodes. For these examples, the reports may be included in report(s) 630.

According to some examples, apparatus 600 may also include a select component 622-6. Select component 622-6 may be executed by circuitry 620 to select an offload node from the one or more nodes based on the one or more reports. For these examples, select component 622-6 may choose the node having the highest available capacity in relation to its energy state threshold compared to available capacity of other nodes that sent report(s) 630 to the first node. A request to offload the computational task from the first node may be included in request 635-1 and sent to the selected offloading node over the OOB communication channel.

In some examples, apparatus 600 may also include a request component 622-7. Request component 622-7 may be executed by circuitry 620 to receive a request to execute a computational task offloaded from the second node. This may occur in situations where the first node is not currently operating at an energy state exceeding its energy state threshold. For these examples, the request from the second node may be included in request 635-2 and may have been generated by the second node responsive to a report previously sent by energy state component 622-2 following receipt of broadcast 610-2 from the second node by message component 622-4. Energy component 622-2 may accept the request received by request component 622-7 based on a determination that the energy state of the first node would not be exceeded if the computational task was offloaded from the second node. Task component 622-1 may then cause the computational task to be executed using computing resources hosted by the first node. The computational task offloaded from the second node may be included in offloaded task 645-1.

According to some examples, apparatus 600 may also include an offload component 622-8. Offload component 622-8 may be executed by circuitry 620 to cause the computational task to be offloaded to the selected offload node responsive to the offload node accepting a request to execute the computational task. The request, for example, may have been included in request 635-1 that was caused to be sent to the offload node by select component 622-6 as mentioned above. Offloaded task 645-2 may include information for the offload node to start executing the offloaded computational task using its hosted computing resources.

Various components of apparatus 600 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

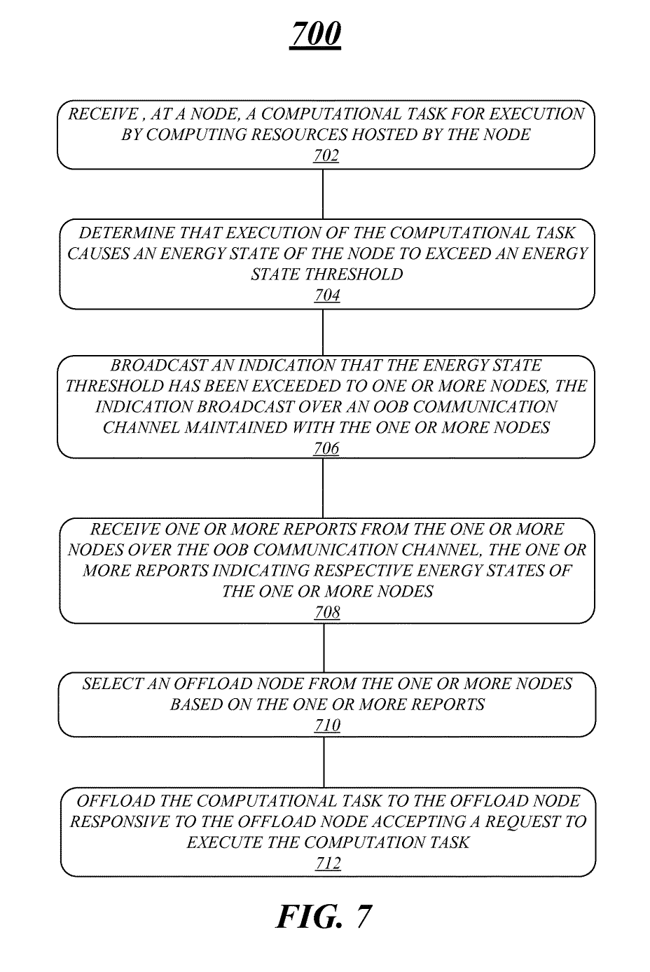

FIG. 7 illustrates an example first logic flow. As shown in FIG. 7, the example first logic flow includes logic flow 700. Logic flow 700 may be representative of some or all of the operations executed by one or more logic, features, or devices described herein, such as apparatus 600. More particularly, logic flow 700 may be implemented by at least task component 622-1, energy state component 622-2, broadcast component 622-3, select component 622-5 or offload component 622-7.

According to some examples, logic flow 700 at block 702 may receive, at a node, a computational task for execution by computing resources hosted by the node. For these examples, task component 622-1 may receive information (e.g., from an OS kernel) associated with execution of the computational task by computing resources hosted by the node.

In some examples, logic flow 700 at block 704 may determine that execution of the computational task causes an energy state of the node to exceed an energy state threshold. For these examples, energy state component 622-2 may make the determination.

According to some examples, logic flow 700 at block 706 may broadcast an indication that the energy state threshold has been exceeded to one or more nodes, the indication broadcast over an OOB communication channel maintained with the one or more nodes. For these examples, broadcast component 622-3 may broadcast the indication.

In some examples, logic flow 700 at block 708 may receive one or more reports from the one or more nodes over the OOB communication channel, the one or more reports indicating respective energy states of the one or more nodes. For these examples, report component 622-5 may receive the one or more reports.

According to some examples, logic flow 700 at block 710 may select an offload node from the one or more nodes based on the one or more reports. For these examples, select component 622-6 may select the offload node.

In some examples, logic flow 700 at block 712 may offload the computational task to the offload node responsive to the offload node accepting a request to execute the computation task. For these examples, offload component 622-8 may cause the computational task to be offloaded.

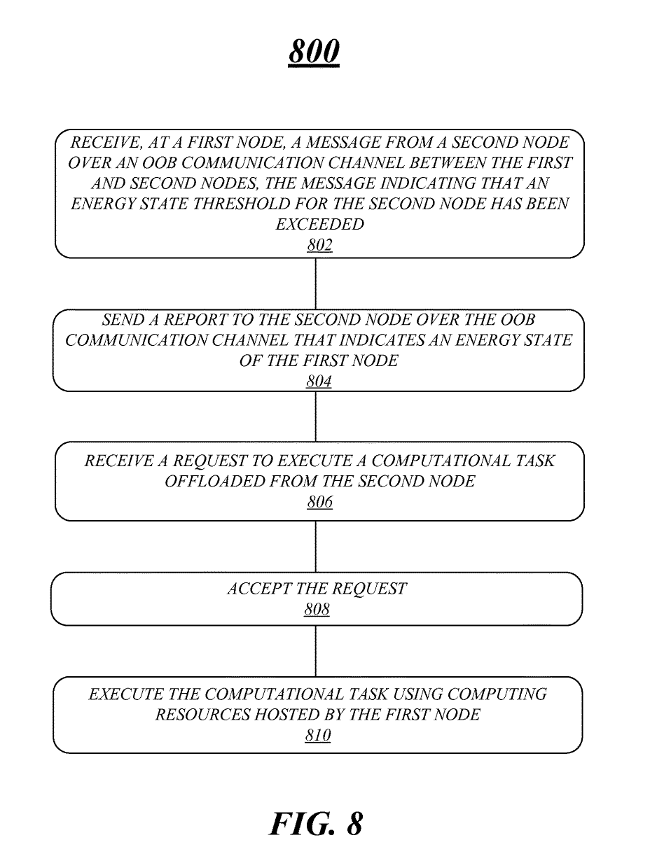

FIG. 8 illustrates an example second logic flow. As shown in FIG. 8, the example second logic flow includes logic flow 800. Logic flow 800 may be representative of some or all of the operations executed by one or more logic, features, or devices described herein, such as apparatus 600. More particularly, logic flow 800 may be implemented by at least message component 622-4, energy state component 622-2, request component 622-7 or task component 622-1.

According to some examples, logic flow 800 at block 802 may receive, at a first node, a message from a second node over an OOB communication channel between the first and second nodes, the message indicating that an energy state threshold for the second node has been exceeded. For these examples, message component 622-4 may receive the message.

In some examples, logic flow 800 at block 804 may send a report to the second node over the OOB communication channel that indicates an energy state of the first node. For these examples, energy state component 622-2 may cause the report to be sent to the second node.

According to some examples, logic flow 800 at block 806 may receive a request to execute a computational task offloaded from the second node. For these examples, request component 622-7 may receive the request.

In some examples, logic flow 800 at block 808 may accept the request. For these examples, energy state component 622-2 may accept the request.

According to some examples, logic flow 800 at block 810 may execute the computational task using computing resources hosted by the first node. For these examples, task component 622-1 may cause the computational task to be executed using the computing resources hosted by the first node.

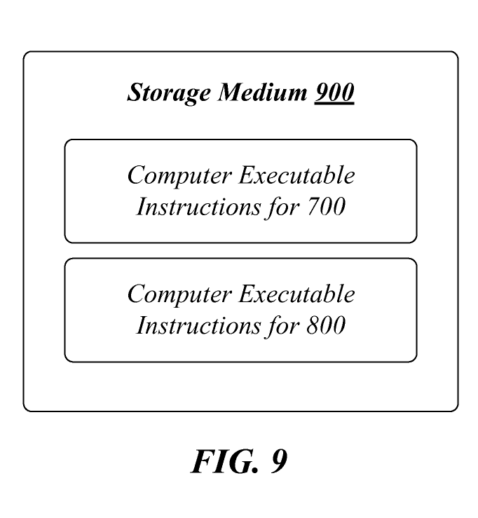

FIG. 9 illustrates an example storage medium 900. As shown in FIG. 9, the first storage medium includes a storage medium 900. The storage medium 900 may comprise an article of manufacture. In some examples, storage medium 900 may include any non-transitory computer readable medium or machine readable medium, such as an optical, magnetic or semiconductor storage. Storage medium 900 may store various types of computer executable instructions, such as instructions to implement logic flow 700 or logic flow 800. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

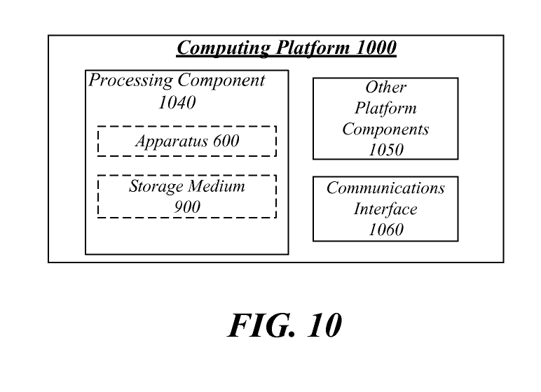

FIG. 10 illustrates an example computing platform 1000. In some examples, as shown in FIG. 10, computing platform 1000 may include a processing component 1040, other platform components 1050 or a communications interface 1060. According to some examples, computing platform 1000 may be included in a node such as one of nodes 110-1 to 110-n shown in FIG. 1 that may be arranged to execute computational tasks for providing at least a portion of a network or data center service.

According to some examples, processing component 1040 may execute processing operations or logic for apparatus 600 and/or storage medium 800. Processing component 1040 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 1050 may include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory), solid state drives (SSD) and any other type of storage media or storage device suitable for storing information.

In some examples, communications interface 1060 may include logic and/or features to support a communication interface. For these examples, communications interface 1060 may include one or more communication interfaces that operate according to various communication protocols or standards to communicate over direct or network communication links. Direct communications may occur via use of communication protocols or standards described in one or more industry standards (including progenies and variants) such as those associated with the PCIe specification. Network communications may occur via use of in-band communication channels that may use in-band communication protocols such those described in one or more Ethernet standards, one or more OpenFlow specifications, the Infiniband Architecture specification or the TCP/IP protocol. Network communications may also occur via use of OOB communication channels that may use OOB communication protocols described in the AMT specification, the IPMI specification or the SNMPv3 standards.

As mentioned above computing platform 1000 may be implemented in a node such as one of nodes 110-1 to 110-n shown in FIG. 1 that may be arranged to execute computational tasks for providing at least a portion of a network or data center service. Accordingly, functions and/or specific configurations of computing platform 1000 described herein, may be included or omitted in various embodiments of computing platform 1000, as suitably desired for a node arranged to execute computational tasks using computing resources hosted by the node.

The components and features of computing platform 1000 may be implemented using any combination of discrete circuitry, application specific integrated circuits (ASICs), logic gates and/or single chip architectures. Further, the features of computing platform 1000 may be implemented using microcontrollers, programmable logic arrays and/or microprocessors or any combination of the foregoing where suitably appropriate. It is noted that hardware, firmware and/or software elements may be collectively or individually referred to herein as “logic”, “circuit”, or “circuitry.”

It should be appreciated that the exemplary computing platform 1000 shown in the block diagram of FIG. 10 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

### Example 1

An example apparatus may include circuitry at a node hosting computing resources. The apparatus may also include a task component for execution by the circuitry to receive information for a computational task to be executed by the computing resources hosted by the node. The apparatus may also include an energy state component for execution by the circuity to determine that execution of the computational task causes an energy state of the node to exceed an energy state threshold. The apparatus may also include a broadcast component for execution by the circuitry to broadcast an indication that the energy state threshold has been exceeded to one or more nodes, the indication broadcast over an OOB communication channel maintained with the one or more nodes. The apparatus may also include a report component for execution by the circuitry to receive one or more reports from the one or more nodes over the OOB communication channel, the one or more reports indicating respective energy states of the one or more nodes. The apparatus may also include a select component for execution by the circuitry to select an offload node from the one or more nodes based on the one or more reports. The apparatus may also include an offload component for execution by the circuitry to cause the computational task to be offloaded to the offload node responsive to the offload node accepting a request to execute the computation task.

### Example 2

The apparatus of example 1, the request to execute the computation tasks may include the energy state component to cause information to be sent over the OOB communication channel to the offload node for the offload node to determine an energy state impact caused by computing resources at the offload node executing the computational task.

### Example 3

The apparatus of example 1, the task component may receive the information for the computational task via an OS kernel of the node. The OS kernel may offload the computational task to the offload node responsive to an indication from the offload component that the offload node has accepted the request.

### Example 4

The apparatus of example 1, the one or more reports indicating respective energy states of the one or more nodes may include the respective energy states indicating available capacity of respective computing resources hosted by the one or more nodes before exceeding respective energy state thresholds for the one or more nodes.

### Example 5

The apparatus of example 4, the select component to select the offload node based on the offload node sending a report that indicates greater available capacity compared to available capacity indicated by other nodes sending reports received by the node.

### Example 6

The apparatus of example 1, the energy state threshold may be based on at least a portion of the computing resources allocated for executing computational tasks received by the node.

### Example 7

The apparatus of example 6, the at least a portion of computing resources allocated may include a given percent allocated. The given percent may be selected from a range of allocations from 0 percent allocated to 100 percent allocated.

### Example 8

The apparatus of example 6, the at least a portion of the computing resources allocated may be based on a cumulative capacity of the computing resources hosted by the node.

### Example 9

The apparatus of example 6, the at least a portion of the computing resources allocated may be based on separate capacities of individual computing resources hosted by the node, the individual computing resources capable of being used to execute computational tasks received by the node.

### Example 10

The apparatus of example 9, the individual computing resources may include one or more of a processor, a memory device, a storage device, a power device, a cooling device, a network input/output device, a switch, a graphics processor, an operating system, a virtual machine, a container or an application.

### Example 11

The apparatus of example 9, the node and the one or more nodes may be included in a data center and the computational task offloaded to the offload node may be for providing at least a portion of a data center service supported by the data center.

### Example 12

The apparatus of example 11, the offload node may receive and transmit data over in-band communication channels when executing the offloaded computational task for providing at least the portion of the data center service.

### Example 13

The apparatus of example 1 may be an AMT management engine. For these examples, the OOB communication channel may be arranged to operate as an AMT OOB communication channel. The offloading node may also include an AMT management engine to facilitate communication over the AMT OOB communication channel.

### Example 14

The apparatus of example 1 may be a BMC. For these examples, the OOB communication channel may be arranged to operate as an IPMI OOB communication channel. The offloading node may also include a BMC to facilitate communication over the IPMI OOB communication channel.

### Example 15

The apparatus of example 1 may be an SNMP agent. For these examples, the OOB communication channel may be arranged to operate as an SNMP OOB communication channel. The offloading node may also include an SNMP agent to facilitate communication over the SNMP OOB communication channel.

### Example 16

The apparatus of example 1 may also include a digital display coupled to the circuitry to present a user interface view.

### Example 17

An example method may include receiving, at a node, a computational task for execution by computing resources hosted by the node. The method may also include determining that execution of the computational task causes an energy state of the node to exceed an energy state threshold. The method may also include broadcasting an indication that the energy state threshold has been exceeded to one or more nodes, the indication broadcast over an OOB communication channel maintained with the one or more nodes. The method may also include receiving one or more reports from the one or more nodes over the OOB communication channel. The one or more reports may indicate respective energy states of the one or more nodes. The method may also include selecting an offload node from the one or more nodes based on the one or more reports. The method may also include offloading the computational task to the offload node responsive to the offload node accepting a request to execute the computation task.

### Example 18

The method of example 17, the request to execute the computation tasks may include the node sending information over the OOB communication channel to the offload node for the offload node to determine an energy state impact caused by computing resources at the offload node executing the computational task.

### Example 19

The method of example 17, the one or more reports indicating respective energy states of the one or more nodes may include the respective energy states indicating available capacity of respective computing resources hosted by the one or more nodes before exceeding respective energy state thresholds for the one or more nodes.

### Example 20

The method of example 19, selecting the offload node may be based on the offload node sending a report that indicates greater available capacity compared to available capacity indicated by other nodes sending reports received by the node.

### Example 21

The method of example 17, the energy state threshold may be based on at least a portion of the computing resources allocated for executing computational tasks received by the node.

### Example 22

The method of example 21, the at least a portion of computing resources allocated may include a given percent allocated, the given percent selected from a range of allocations from 0 percent allocated to 100 percent allocated.

### Example 23

The method of example 21, the at least a portion of the computing resources allocated may be based on a cumulative capacity of the computing resources hosted by the node.

### Example 24

The method of example 21, the at least a portion of the computing resources allocated may be based on separate capacities of individual computing resources hosted by the node. The individual computing resources may be capable of being used to execute computational tasks received by the node.

### Example 25

The method of example 24, the individual computing resources may include one or more of a processor, a memory device, a storage device, a power device, a cooling device, a network input/output device, a switch, a graphics processor, an operating system, a virtual machine, a container or an application.

### Example 26

The method of example 17, the node and the one or more nodes may be included in a data center and the computational task for offloading to the offload node is for providing at least a portion of a data center service supported by the data center.

### Example 27

The method of example 26, the offload node may receive and transmit data over in-band communication channels when executing the offloaded computational task for providing at least the portion of the data center service.

### Example 28

The method of example 17, the OOB communication channel may include an AMT OOB communication channel. For these examples, the node and the offloading node may separately include a management engine to facilitate communication over the AMT OOB communication channel.

### Example 29

The method of example 17, the OOB communication channel may be an IPMI OOB communication channel. For these examples, the node and the offloading node may separately include a BMC to facilitate communication over the IPMI OOB communication channel.

### Example 30

The method of example 17, the OOB communication channel may be an SNMP OOB communication channel. For these examples, the node and the offloading node may separately include an agent to implement an SNMP interface to facilitate communication over the SNMP OOB communication channel.

### Example 31

An example at least one machine readable medium may include a plurality of instructions that in response to being executed by system cause the system to carry out a method according to any one of examples 17 to 30.

### Example 32

An example apparatus may include means for performing the methods of any one of examples 17 to 30.

### Example 33

An example at least one machine readable medium may include a plurality of instructions that in response to being executed by a system of at a node hosting computing resources cause the system to receive a computational task for execution by computing resources hosted by the node. The instructions may also cause the system to determine that execution of the computational task causes an energy state of the node to exceed an energy state threshold. The instructions may also cause the system to broadcast an indication that the energy state threshold has been exceeded to one or more nodes. The indication may be broadcast over an OOB communication channel maintained with the one or more nodes. The instructions may also cause the system to receive one or more reports from the one or more nodes over the OOB communication channel, the one or more reports indicating respective energy states of the one or more nodes. The instructions may also cause the system to select an offload node from the one or more nodes based on the one or more reports. The instructions may also cause the system to offload the computational task to the offload node responsive to the offload node accepting a request to execute the computation task.

### Example 34

The at least one machine readable medium of example 33, the request to execute the computation tasks may include the instructions to cause the system to send information over the OOB communication channel to the offload node for the offload node to determine an energy state impact caused by computing resources at the offload node executing the computational task.

### Example 35

The at least one machine readable medium of example 33, the one or more reports indicating respective energy states of the one or more nodes may include the respective energy states indicating available capacity of respective computing resources hosted by the one or more nodes before exceeding respective energy state thresholds for the one or more nodes.

### Example 36

The at least one machine readable medium of example 35, the instructions may cause the system to select the offload node based on the offload node sending a report that indicates greater available capacity compared to available capacity indicated by other nodes sending reports received by the node.

### Example 37

The at least one machine readable medium of example 33, the energy state threshold may be based on at least a portion of the computing resources allocated for executing computational tasks received by the node.

### Example 38

The at least one machine readable medium of example 37, the at least a portion of computing resources allocated may include a given percent allocated, the given percent selected from a range of allocations from 0 percent allocated to 100 percent allocated.

### Example 39

The at least one machine readable medium of example 37, the at least a portion of the computing resources allocated may be based on a cumulative capacity of the computing resources hosted by the node.

### Example 40

The at least one machine readable medium of example 37, the at least a portion of the computing resources allocated may be based on separate capacities of individual computing resources hosted by the node. The individual computing resources may be capable of being used to execute computational tasks received by the node.

### Example 41

The at least one machine readable medium of example 40, the individual computing resources may include one or more of a processor, a memory device, a storage device, a power device, a cooling device, a network input/output device, a switch, a graphics processor, an operating system, a virtual machine, a container or an application.

### Example 42

The at least one machine readable medium of example 33, the node and the one or more nodes may be included in a data center and the computational task for offloading to the offload node is for providing at least a portion of a data center service supported by the data center.

### Example 43

The at least one machine readable medium of example 42, the offload node may receive and transmit data over in-band communication channels when executing the offloaded computational task for providing at least the portion of the data center service.

### Example 44

The at least one machine readable medium of example 33, the OOB communication channel may be an AMT OOB communication channel. For these examples, the node and the offloading node may separately include a management engine to facilitate communication over the AMT OOB communication channel.

### Example 45

The at least one machine readable medium of example 33, the OOB communication channel may be an IPMI OOB communication channel. For these examples, the node and the offloading node may separately include a BMC to facilitate communication over the IPMI OOB communication channel.

### Example 46

The at least one machine readable medium of example 33, the OOB communication channel may be an SNMP OOB communication channel. For these examples, the node and the offloading node may separately include an agent to implement an SNMP interface to facilitate communication over the SNMP OOB communication channel.

### Example 47

An example apparatus may include circuitry at a first node. The apparatus may also include a message component for execution by the circuitry to receive a message from a second node over an OOB communication channel between the first and second nodes. The message may indicate that an energy state threshold for the second node has been exceeded. The apparatus may also include an energy state component for execution by the circuitry to cause a report to be sent to the second node over the OOB communication channel that indicates an energy state of the first node. The apparatus may also include a request component for execution by the circuitry to receive a request to execute a computational task offloaded from the second node. The apparatus may also include the energy state component to accept the request. The apparatus may also include a task component for execution by the circuitry to cause the computational task to be executed using computing resources hosted by the first node.

### Example 48

The apparatus of example 47, the request to execute the computational task may include information for the energy state component to determine whether an energy state of the first node would exceed an energy state threshold for the first node if the computational task was executed by the computing resources hosted by the first node. The energy state component may accept the request based on determining that the energy state of the first node will not exceed the energy state threshold for the first node.

### Example 49

The apparatus of example 47, the energy state of the first node included in the report sent to the second node may include the energy state indicating available capacity of computing resources hosted by the first node before exceeding an energy state threshold for the first node.

### Example 50

The apparatus of example 47, the energy state threshold for the first node may be based on at least a portion of the computing resources hosted by the first node that are allocated for executing computational tasks received by the first node.

### Example 51

The apparatus of example 50, the at least a portion of computing resources allocated may include a given percent allocated, the given percent selected from a range of allocations from 0 percent allocated to 100 percent allocated.

### Example 52

The apparatus of example 51, the at least a portion of the computing resources allocated may be based on a cumulative capacity of the computing resources hosted by the first node.

### Example 53

The apparatus of example 51, the at least a portion of the computing resources allocated may be based on separate capacities of individual computing resources hosted by the first node, the individual computing resources capable of being used to execute computational tasks received by the first node.

### Example 54

The apparatus of example 53, the individual computing resources may include one or more of a processor, a memory device, a storage device, a power device, a cooling device, a network input/output device, a switch, a graphics processor, an OS, a virtual machine, a container or an application.

### Example 55

The apparatus of example 47, the first and second nodes included in a data center and the computational task offloaded from the second node may be for providing at least a portion of a data center service supported by the data center.

### Example 56

The apparatus of example 55, the first node may receive and transmit data over in-band communication channels when executing the computational task for providing at least the portion of the data center service.

### Example 57

The apparatus of example 47 may be an AMT management engine. For these examples, the OOB communication channel may be arranged to operate as an AMT OOB communication channel. The second node may also include an AMT management engine to facilitate communication over the AMT OOB communication channel.

### Example 58

The apparatus of example 47 may be a BMC, the OOB communication channel is arranged to operate as an IPMI OOB communication channel. For these examples, the second node may also include a BMC to facilitate communication over the IPMI OOB communication channel.

### Example 59

The apparatus of example 47 may be an SNMP agent. For these examples, the OOB communication channel may be arranged to operate as an SNMP OOB communication channel. The second node may also include an SNMP agent to facilitate communication over the SNMP OOB communication channel.

### Example 60

The apparatus of example 47 may also include a digital display coupled to the circuitry to present a user interface view.

### Example 61

An example method may include receiving, at a first node, a message from a second node over an OOB communication channel between the first and second nodes. The message may indicate that an energy state threshold for the second node has been exceeded. The method may also include sending a report to the second node over the OOB communication channel that indicates an energy state of the first node. The method may also include receiving a request to execute a computational task offloaded from the second node. The method may also include accepting the request. The method may also include executing the computational task using computing resources hosted by the first node.

### Example 62

The method of example 61, the request to execute the computational task includes information for determining whether an energy state of the first node would exceed an energy state threshold for the first node if the computational task was executed by the computing resources hosted by the first node. For these examples, accepting the request may be based on determining that the energy state of the first node will not exceed the energy state threshold for the first node.

### Example 63

The method of example 61, sending the report to the second node over the OOB communication channel that indicates an energy state of the first node may include the energy state of the first node indicating available capacity of computing resources hosted by the first node before exceeding an energy state threshold for the first node.

### Example 64

The method of example 61, the energy state threshold for the first node may be based on at least a portion of the computing resources hosted by the first node that are allocated for executing computational tasks received by the first node.

### Example 65

The method of example 64, the at least a portion of computing resources allocated may include a given percent allocated, the given percent selected from a range of allocations from 0 percent allocated to 100 percent allocated.

### Example 66

The method of example 65, the at least a portion of the computing resources allocated may be based on a cumulative capacity of the computing resources hosted by the first node.

### Example 67

The method of example 65, the at least a portion of the computing resources allocated may be based on separate capacities of individual computing resources hosted by the first node. The individual computing resources may be capable of being used to execute computational tasks received by the first node.

### Example 68

The method of example 67, the individual computing resources may include one or more of a processor, a memory device, a storage device, a power device, a cooling device, a network input/output device, a switch, a graphics processor, an OS, a virtual machine, a container or an application.

### Example 69

The method of example 61, the first and second nodes may be included in a data center and the computational task offloaded from the second node may be for providing at least a portion of a data center service supported by the data center.

### Example 70

The method of example 69, the first node may receive and transmit data over in-band communication channels when executing the computational task for providing at least the portion of the data center service.

### Example 71

The method of example 61, the OOB communication channel may be an AMT OOB communication channel. For these examples, the first and second nodes may separately include a management engine to facilitate communication over the AMT OOB communication channel.

### Example 72

The method of example 61, the OOB communication channel may be an IPMI OOB communication channel. For these examples, the first and second nodes may separately include a BMC to facilitate communication over the IPMI OOB communication channel.

### Example 73

The method of example 61, the OOB communication channel may be an SNMP OOB communication channel. For these examples, the first and second nodes may separately include an agent to implement an SNMP interface to facilitate communication over the SNMP OOB communication channel.

### Example 74

An example at least one machine readable medium may include a plurality of instructions that in response to being executed by system cause the system to carry out a method according to any one of examples 61 to 73.

### Example 75

An example apparatus may include means for performing the methods of any one of examples 61 to 73.

### Example 76

At least one machine readable medium may include a plurality of instructions that in response to being executed by a system at a first node hosting computing resources cause the system to receive a message from a second node over an OOB communication channel between the first and second nodes. The message may indicate that an energy state threshold for the second node has been exceeded. The instructions may also cause the system to send a report to the second node over the OOB communication channel that indicates an energy state of the first node. The instructions may also cause the system to receive a request to execute a computational task offloaded from the second node. The instructions may also cause the system to accept the request and cause the computational task to be executed using computing resources hosted by the first node.

### Example 77

The at least one machine readable medium of example 76, the request to execute the computational task may include information for determining whether an energy state of the first node would exceed an energy state threshold for the first node if the computational task was executed by the computing resources hosted by the first node. For these examples, the instructions to cause the system to accept the request may be based on the system determining that the energy state of the first node will not exceed the energy state threshold for the first node.

### Example 78

The at least one machine readable medium of example 76, the instructions to cause the system to send the report to the second node over the OOB communication channel that indicates an energy state of the first node may include the energy state of the first node indicating available capacity of computing resources hosted by the first node before exceeding an energy state threshold for the first node.

### Example 79

The at least one machine readable medium of example 76, the energy state threshold for the first node may be based on at least a portion of the computing resources hosted by the first node that are allocated for executing computational tasks received by the first node.

### Example 80

The at least one machine readable medium of example 79, the at least a portion of computing resources allocated may include a given percent allocated, the given percent selected from a range of allocations from 0 percent allocated to 100 percent allocated.

### Example 81

The at least one machine readable medium of example 80, the at least a portion of the computing resources allocated may be based on a cumulative capacity of the computing resources hosted by the first node.

### Example 82

The at least one machine readable medium of example 80, the at least a portion of the computing resources allocated may be based on separate capacities of individual computing resources hosted by the first node. The individual computing resources may be capable of being used to execute computational tasks received by the first node.

### Example 83

The at least one machine readable medium of example 82, the individual computing resources may include one or more of a processor, a memory device, a storage device, a power device, a cooling device, a network input/output device, a switch, a graphics processor, an OS, a virtual machine, a container or an application.

### Example 84

The at least one machine readable medium of example 76, the first and second nodes included in a data center and the computational task offloaded from the second node may be for providing at least a portion of a data center service supported by the data center.

### Example 85

The at least one machine readable medium of example 84, the first node may receive and transmit data over in-band communication channels when executing the computational task for providing at least the portion of the data center service.

### Example 86

The at least one machine readable medium of example 76, the system may be an AMT management engine. For these examples, the OOB communication channel is arranged to operate as an AMT OOB communication channel. The second node may also include an AMT management engine to facilitate communication over the AMT OOB communication channel.

### Example 87

The at least one machine readable medium of example 76, the system may be a BMC. For these examples, the OOB communication channel may be arranged to operate as an IPMI OOB communication channel. The second node may also include a BMC to facilitate communication over the IPMI OOB communication channel.

### Example 88

The at least one machine readable medium of example 76, the system may be an SNMP agent. For these examples, the OOB communication channel may be arranged to operate as an SNMP OOB communication channel. The second node may also include an SNMP agent to facilitate communication over the SNMP OOB communication channel.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. At least one non-transitory machine readable medium comprising a plurality of instructions that in response to being executed by a system at a first node hosting computing resources cause the system to:
receive a message from a second node over an out-of-band (OOB) communication channel between the first and second nodes, the message indicating that an energy state threshold for the second node has been exceeded;
send a report to the second node over the OOB communication channel that indicates an energy state of the first node;
receive a request to execute a computational task offloaded from the second node the request to execute the computational task including information to determine whether an energy state of the first node would exceed an energy state threshold for the first node if the computational task was executed by the computing resources hosted by the first node;
accept the request based on a determination that the energy state of the first node would not exceed the energy state threshold for the first node; and
cause the computational task to be executed using computing resources hosted by the first node.

2. (canceled)

3. The at least one machine readable medium of claim 1, the instructions to cause the system to send the report to the second node over the OOB communication channel that indicates an energy state of the first node comprises the energy state of the first node indicating available capacity of computing resources hosted by the first node before exceeding an energy state threshold for the first node.

4. The at least one machine readable medium of claim 1, the energy state threshold for the first node is based on at least a portion of the computing resources hosted by the first node that are allocated for executing computational tasks received by the first node.

5. The at least one machine readable medium of claim 4, the at least a portion of computing resources allocated comprises a given percent allocated, the given percent selected from a range of allocations from 0 percent allocated to 100 percent allocated.

6. The at least one machine readable medium of claim 5, the at least a portion of the computing resources allocated is based on a cumulative capacity of the computing resources hosted by the first node.

7. The at least one machine readable medium of claim 5, the at least a portion of the computing resources allocated is based on separate capacities of individual computing resources hosted by the first node, the individual computing resources capable of being used to execute computational tasks received by the first node.

8. The at least one machine readable medium of claim 7, the individual computing resources comprising one or more of a processor, a memory device, a storage device, a power device, a cooling device, a network input/output device, a switch, a graphics processor, an operating system (OS), a virtual machine, a container or an application.

9. The at least one machine readable medium of claim 1, the first and second nodes included in a data center and the computational task offloaded from the second node is for providing at least a portion of a data center service supported by the data center, the first node to receive and transmit data over in-band communication channels when executing the computational task for providing at least the portion of the data center service.

10. An apparatus comprising:
circuitry at a node hosting computing resources;
a task component for execution by the circuitry to receive information for a computational task to be executed by the computing resources hosted by the node;
an energy state component for execution by the circuitry to determine that execution of the computational task causes an energy state of the node to exceed an energy state threshold;
a broadcast component for execution by the circuitry to broadcast an indication that the energy state threshold has been exceeded to one or more nodes, the indication broadcast over an out-of-band (OOB) communication channel maintained with the one or more nodes;
a report component for execution by the circuitry to receive one or more reports from the one or more nodes over the OOB communication channel, the one or more reports indicating respective energy states of the one or more nodes;
a select component for execution by the circuitry to select an offload node from the one or more nodes based on the one or more reports; and
an offload component for execution by the circuitry to:
cause the energy state component to send information over the OOB communication channel to the offload node for the offload node to determine an energy state impact caused by computing resources at the offload node executing an energy state threshold; and
cause the computational task to be offloaded to the offload node responsive to the offload node accepting a request to execute the computation task, request conditioned on a determination that the energy state impact caused by the computing resources at the offload node would not exceed the energy state threshold.

11. (canceled)

12. The apparatus of claim 10, the task component to receive the information for the computational task via an operating system (OS) kernel of the node, the OS kernel to offload the computational task to the offload node responsive to an indication from the offload component that the offload node has accepted the request.

13. The apparatus of claim 10, the one or more reports indicating respective energy states of the one or more nodes comprises the respective energy states indicating available capacity of respective computing resources hosted by the one or more nodes before exceeding respective energy state thresholds for the one or more nodes, the select component to select the offload node based on the offload node sending a report that indicates greater available capacity compared to available capacity indicated by other nodes sending reports received by the node.

14. The apparatus of claim 10, the energy state threshold is based on at least a portion of the computing resources allocated for executing computational tasks received by the node, the at least a portion of computing resources allocated comprises a given percent allocated, the given percent selected from a range of allocations from 0 percent allocated to 100 percent allocated.

15. The apparatus of claim 10, the apparatus comprising an active management technology (AMT) management engine, the OOB communication channel is arranged to operate as an AMT OOB communication channel, the offloading node also including an AMT management engine to facilitate communication over the AMT OOB communication channel.

16. The apparatus of claim 10, comprising a digital display coupled to the circuitry to present a user interface view.

17. A method comprising:
receiving, at a node, a computational task for execution by computing resources hosted by the node;
determining that execution of the computational task causes an energy state of the node to exceed an energy state threshold;
broadcasting an indication that the energy state threshold has been exceeded to one or more nodes, the indication broadcast over an out-of-band (OOB) communication channel maintained with the one or more nodes;
receiving one or more reports from the one or more nodes over the OOB communication channel, the one or more reports indicating respective energy states of the one or more nodes;
selecting an offload node from the one or more nodes based on the one or more reports;
sending information over the OOB communication channel to the offload node for the offload node to determine an energy state impact caused by computing resources at the offload node executing an energy state threshold; and
offloading the computational task to the offload node responsive to the offload node accepting a request to execute the computation task, request conditioned on a determination that the energy state impact caused by the computing resources at the offload node would not exceed the energy state threshold.

18. The method of claim 17, the one or more reports indicating respective energy states of the one or more nodes comprises the respective energy states indicating available capacity of respective computing resources hosted by the one or more nodes before exceeding respective energy state thresholds for the one or more nodes.

19. The method of claim 18, selecting the offload node based on the offload node sending a report that indicates greater available capacity compared to available capacity indicated by other nodes sending reports received by the node.

20. The method of claim 17, the energy state threshold is based on at least a portion of the computing resources allocated for executing computational tasks received by the node, the at least a portion of computing resources allocated including a given percent allocated, the given percent selected from a range of allocations from 0 percent allocated to 100 percent allocated.

21. The method of claim 20, the at least a portion of the computing resources allocated is based on separate capacities of individual computing resources hosted by the node, the individual computing resources capable of being used to execute computational tasks received by the node,
the individual computing resources including one or more of a processor, a memory device, a storage device, a power device, a cooling device, a network input/output device, a switch, a graphics processor, an operating system, a virtual machine, a container or an application.

22. The method of claim 17, the node and the one or more nodes are included in a data center and the computational task for offloading to the offload node is for providing at least a portion of a data center service supported by the data center, the offload node to receive and transmit data over in-band communication channels when executing the offloaded computational task for providing at least the portion of the data center service.

23. The method of claim 17, the OOB communication channel comprising an active management technology (AMT) OOB communication channel, the node and the offloading node separately including a management engine to facilitate communication over the AMT OOB communication channel.

24. The method of claim 17, the OOB communication channel comprising an intelligent platform management interface (IPMI) OOB communication channel, the node and the offloading node separately including a baseband management controller (BMC) to facilitate communication over the IPMI OOB communication channel.

25. The method of claim 17, the OOB communication channel comprising a simple network management protocol (SNMP) OOB communication channel, the node and the offloading node separately including an agent to implement an SNMP interface to facilitate communication over the SNMP OOB communication channel.
